(19) United States
(12) Patent Application Publication
(10) Pub. No.: US 2022/0042651 A1
(43) Pub. Date: Feb. 10, 2022

(54) SUPPORT DEVICE AND STORAGE CONTAINER FOR LIQUEFIED GAS

(71) Applicant: L'Air Liquide, Societe Anonyme pour I'Etude et I'Exploitation des Precedes Georges Claude, Paris (FR)

(72) Inventor: Jean-Luc FOURNEL, Sassenage (FR)

(21) Appl. No.: 17/312,872

(22) PCT Filed: Dec. 4, 2019
(86) PCT No.: PCT/FR2019/052923

§ 371 Date: Jun. 10, 2021

(30) Foreign Application Priority Data
Dec. 11, 2018 (FR) 1872652

(51) Int. Cl. F17C 13/00

(52) U.S. Cl. CPC F17C 13/001; F17C 2223/0161; F17C 2203/0629; F17C 2203/0391; F17C 2203/0648; F17C 2203/0643; F17C 2270/0173; F17C 2203/018; F17C 2203/0312; F17C 2203/0366; F17C 2221/017; F17C 2260/033; F17C 2201/0109

(57) ABSTRACT

A storage container for liquefied gas, having a first, inner tank extending in a horizontal longitudinal direction and configured to store the liquefied gas, a second, outer tank disposed around the first tank, the container having a device for supporting the first tank in the second tank, the support device having a fixed and rigid connection extending in a longitudinal direction (A) between one end of the second tank and an adjacent end of the first tank, the fixed and rigid connection including a set of walls forming back-and-forths in the longitudinal direction (A) to constitute a thermal insulation path between the second tank and the first tank, wherein the set of walls forming back-and-forths in the longitudinal direction (A) of the fixed and rigid connection has at least one wall made of titanium.

### CROSS REFERENCE TO RELATED APPLICATIONS

This application is a 371 of International Application No. PCT/FR2019/052923, filed Dec. 4, 2019, which claims priority to French Patent Application No. 1872652, filed Dec. 11, 2018, the entire contents of which are incorporated herein by reference.

### BACKGROUND

The invention relates to support devices and storage containers for cryogenic fluids.

The invention relates more particularly to a device for supporting a first cryogenic equipment in a second equipment, the first equipment being intended to be maintained at a cryogenic temperature while the second equipment is intended to be maintained at a temperature higher than the temperature of the first equipment, the support device comprising a fixed and rigid connection extending in a longitudinal direction between, on the one hand, one end of the second equipment and, on the other hand, an adjacent end of the first equipment, the fixed and rigid connection including a set of walls forming back-and-forths in the longitudinal direction to constitute a thermal insulation path between, on the one hand, the second equipment and, on the other hand, the first equipment.

The fixed inner supports of cryogenic equipment are commonly called “fixed necks” in the field of fixed or mobile cryogenic vessels, or “fixed points” or “vacuum barriers” in the field of cryostats (valve boxes, cold boxes, transfer vacuum lines, etc.).

The invention applies in particular to containers for storing (and where appropriate transporting) cryogenic fluids such as helium. However, the invention also applies to other equipment and in particular those listed above.

These fixed inner supports block the movement of a cold element (tank or piping or any other equipment) relative to a warmer outer structural element. These supports take up the forces applied to this inner equipment (self-weight, bottom effect due to pressure, acceleration due to transport, to handling and/or to earthquakes, etc.). The design of these fixed inner supports is a compromise between high mechanical strength and minimal thermal losses.

For example, double-envelope cryogenic tanks have a fixed neck which makes it possible to support, in the outer tank, the inner storage tank (and a possible heat shield such as a nitrogen guard). The fixed neck also takes up dynamic forces. It blocks the axial movements of the inner tank (and of the nitrogen guard, as the case may be).

The fixed support (fixed neck) must be sized to take for example an axial acceleration of 2 g in transport mode and a vertical acceleration of 4 g during handling. For containers approved for rail transport, the fixed support must also be sized to withstand an axial acceleration of 4.5 g when buffering the wagons. In this load case, the fixed support is subjected to a force of 74 tonnes.

The fixed support is conventionally designed like vacuum barriers with thin concentric ferrules (tubes) making it possible to obtain a long thermal path between the two elements at different temperatures.

Generally, acceptable heat losses via the fixed support are of the order of 10 W in the case of a heat shield formed by a nitrogen guard and 0.5 W for the inner tank containing helium.

For extreme conditions of very high loads and low thermal losses, the commonly used design has one of the ferrules of the thermal path made of epoxy/glass composite. This wall made of an epoxy/glass composite material has good mechanical characteristics, low conductivity and good cold behavior.

In known architectures, the inner tank and the possible heat shield are supported by radial tie rods connected to the outer tank. In this configuration, the fixed connection reacts only axial forces.

The epoxy/glass ferrule is secured to adjacent parts by adhesive bonding. However, this adhesive bonding is difficult to master in production.

In addition, this composite wall has little or no ductility or capacity for elongation (the elastic limit is very close to failure). Thus, in the event of impact or accidental overload, the composite shell cannot absorb this overload by plastic deformation. This lack of adaptability leads to failure of the shell and negatively affects the reliability of the equipment.

In addition, this structure cannot react significant bending moments (limitation of the skin stress) which makes it necessary to have an additional support system (tie rods for example in the case of containers).

### SUMMARY

An aim of the present invention is to overcome all or some of the aforementioned drawbacks of the prior art.

To that end, the device according to the invention, moreover in accordance with the generic definition given in the preamble above, is essentially characterized in that the set of walls forming back-and-forths in the longitudinal direction of the fixed and rigid connection comprises at least one wall made of titanium.

Furthermore, embodiments of the invention can comprise one or more of the following features:
the at least one wall made of titanium has a thickness of between 1 mm and 5 mm and in particular equal to 3 mm,
the at least one wall made of titanium is a tubular wall,
the set of walls forming back-and-forths in the longitudinal direction comprises at least one wall made of stainless steel and in particular two walls of stainless steel arranged in series and respectively forming a back-and-forth in the longitudinal direction,
the at least one wall made of titanium consists of at least one of the materials among: TA6V ELI, Ti-5Al-2.5Sn ELI, Ti 6Al 2Zn 4Zr 2Mo and TA6V.

The invention also relates to a container for storing liquefied gas, in particular cryogenic fluid such as helium, comprising a first, inner tank extending in a longitudinal direction and intended to store the liquefied gas, a second, outer tank arranged around the first tank with a vacuum insulated spacing between the first and the second tank, the container comprising a device for supporting the first tank in the second tank, said supporting device conforming to any one of the characteristics above or below.

According to other possible distinguishing features;
the device for holding the first tank in the second tank comprises two stainless steel walls arranged in series in the thermal path between the two tanks and respectively forming a back-and-forth in the longitudinal direction, the two stainless steel walls being arranged in series between the second tank and an intermediate element of the container, the device for holding the first tank in the second tank further comprising at least one titanium wall arranged in series, between the intermediate element of the container and the first tank or a structural element secured to the first tank,
the two longitudinal ends of the at least one titanium wall are respectively fixed to the intermediate element of the container and to a structural element secured to the first tank,
a longitudinal end of the at least one titanium wall is fixed to the structural element secured to the first tank, said structural element being a tubular neck secured to the first tank,
the intermediate element of the container comprises a heat shield arranged between the first and the second tank,
the heat shield is cooled by a cryogenic fluid, in particular containing a reserve of cryogenic fluid,
the container comprises (or does not comprise) a set of tie rods having a first end connected to the second tank and a second end rigidly connected to the first tank and/or to the intermediate element.

The invention can also relate to any alternative device or method comprising any combination of the features above or below, within the scope of the claims.

### BRIEF DESCRIPTION OF THE DRAWINGS

Further distinguishing features and advantages will become apparent upon reading the following description, which is provided with reference to the figures, in which:

FIG. 1 is a schematic and partial sectional view illustrating an example of a support device structure in the case of a container,

FIG. 2 shows a view similar to that of FIG. 1 in a simplified version,

FIG. 3 represents a schematic and partial view in longitudinal section, illustrating an example of a container or tank which may include such a support device.

### DETAILED DESCRIPTION OF PREFERRED EMBODIMENTS

An example of a support device will now be described in the application of a cryogenic container or tank. As mentioned above, this example is entirely non-limiting. All or part of the described support structure can be used in other applications for supporting a first equipment in or on a second equipment.

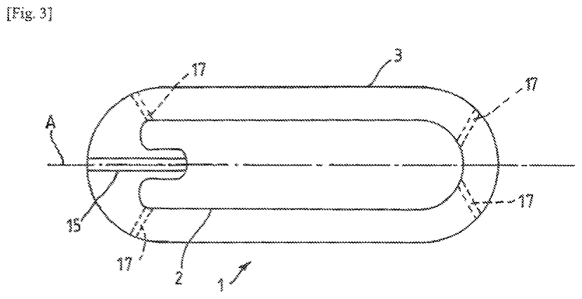

The liquefied gas storage container illustrated in FIG. 3 is configured to store a cryogenic fluid such as helium, for example.

The container comprises a first, inner tank 2, which is for example cylindrical, extending in a longitudinal direction A and intended to store the liquefied gas, and a second, outer tank 3 arranged around the first tank 2 with a vacuum-insulated spacing between the first 2 and the second 3 tank. In the position of use, the longitudinal direction of the container is horizontal, That is to say that the container is of the horizontal type.

The container 1 comprises, at one of its longitudinal ends, a device 15 for supporting the first, inner tank 2 in the second, outer tank 3.

The support device 15 comprises a fixed and rigid connection extending in a longitudinal direction A between, on the one hand, one end of the outer tank and, on the other hand, an adjacent end of the inner tank 2. That is to say that, in the configuration of use of the container 1, the support device 15 forms a horizontal mechanical connection which holds the first tank 2 in the second tank 3 at a longitudinal end (in a cantilever manner, for example), This fixed and rigid connection comprises a set of walls 4, 5, 6, 7, which are for example tubular, constituting an insulating thermal path forming back-and-forths in the longitudinal direction A between, on the one hand, the second tank 3 and the first tank 2.

The set of walls forming back-and-forths in the longitudinal direction A of the fixed and rigid connection 15 comprises at least one wall 6 made of titanium. That is to say that the wall (ferrule) made of epoxy/glass composite material) of the prior art can be replaced with a wall 6 made of titanium.

The grade of titanium used may be TA6V ELI. Other grades can be used, for example Ti-5Al-2.5Sn ELI, Ti 6Al 2Zn 4Zr 2Mo and TA6V (but for the latter preferably limited to use up to 80K).

This titanium wall 6 may have a thickness of between 1 mm and 5 mm and in particular 3 mm.

The TA6V ELI grade makes it possible to give the titanium wall 6 a possible elongation of about 5% at a temperature of 4K.

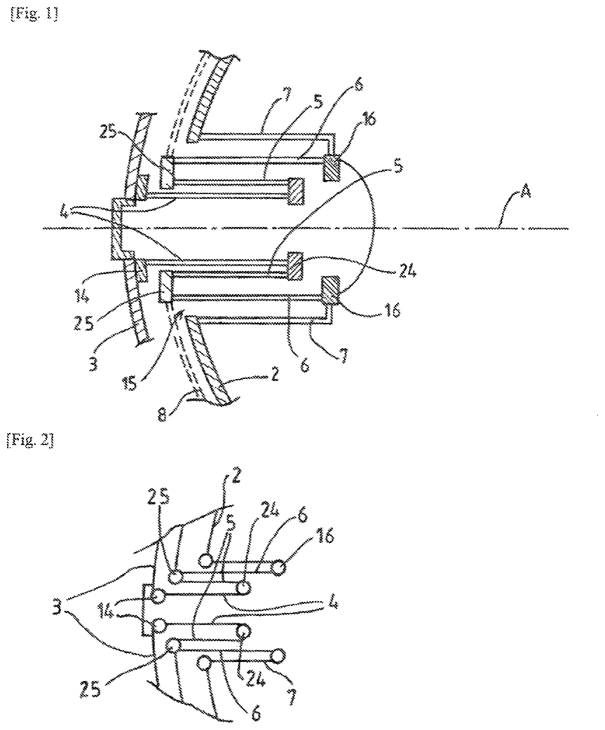

In the example of FIG. 1 and FIG. 2, the container comprises a heat shield 8, 25 interposed between the first 2 and the second 3 tank. The heat shield 8, 25 can be a wall cooled by a reserve of cold fluid (nitrogen for example). Likewise, the heat shield 8 can be a hollow wall which contains the cold cooling fluid (for example a storage volume delimited by two tubular walls).

In the example of FIG. 1 and FIG. 2, the support device comprises two walls or ferrules 4, 5 made of stainless steel. These two wads 4, 5 may have a thickness of between 1 mm and 6 mm, and in particular 5 mm. These two walls 4, 5 form the first part of the thermal path between the second tank 3 (at the outside temperature for example of about 300K) and the heat shield 8, 25 (at a temperature of about 80K for example).

The following titanium wall 6 (ferrule) connects the heat shield 8, 25 to the first, inner tank 2 (the temperature of which may be of the order of 4K).

The ends of the two steel ferrules 4, 5 can be secured to the other parts of the connection via rings or flanges 14, 24 welded to each of their ends. For example a first flange 14 ensures the connection of a first end (“outer”) of the first wall 4 with the second outer tank 3 or an element which is secured to it. A second flange 24 connects a second (“inner”) end of the first wall 4 with a first (“inner”) end of the second wall 5 made of steel.

The second (“outer”) end of the second wall 5 can be connected to the first “outer”) end of the titanium wall 6 via a flange 25.

Finally, the second (“inner”) end of the titanium wall 6 can be connected to an (“inner”) end of a tubular neck 7 secured to the first tank 2.

The qualifiers “outer” and “inner” refer to the relative positions respectively in relation to the center of the container in the longitudinal direction A. The walls 4, 5, 6, 7 of the support device form concentric inner/outer back-and-forths to constitute a thermal insulation path between the two tanks 3, 2.

The ends of the titanium wall 6 can be fixed by a screw-fitted assembly and/or by welding.

Titanium has very high mechanical characteristics with a coefficient of thermal conductivity twice as low as stainless steel. These two properties, combined with the architecture of the support device, make it possible to design a support device having thermal performance equivalent to devices using a ferrule made of composite material.

This architecture confers sufficient strength of the first tank 2 in the second tank 3, making it possible to dispense with tie rods 17 in particular at the longitudinal end of the container which is opposite the support device 15 (cf. FIG. 3).

That is to say that the holding device 15 can ensure the holding and the integrity also of the first tank 2 (and of the heat shield 8) both for axial movements (longitudinal direction A) and lateral movements.

This possible elimination of the tie rods 17 makes it possible to simplify the design, reduce costs and improve the insulation of the tanks (in particular by eliminating insulation defects at internal attachment zones).

According to the invention, the risks of brittle failure in the event of impact or accidental overloading (making the containers more reliable) are eliminated or significantly reduced.

Of course, the invention is not limited to the exemplary embodiment described above. In particular, the support device may include a different number of walls forming a thermal path via back-and-forths. For example, the support device may include one, two or more than two steel walls and one, two or more than two titanium walls. The number of back-and-forths can be increased in accordance with higher insulation performance. Likewise, the order of arrangement of the wads (steel and titanium) can be adapted between the two equipments to be connected.

Thus according to an advantageous feature, the rigid connection is preferably composed of stainless steel and titanium and does not include any resin, in particular epoxy.

The support device 15 can extend longitudinally on the central longitudinal axis of the container as shown in FIG. 3.

Of course, the support device 15 can extend longitudinally horizontally in a plane other than the plane of the central longitudinal axis of the container 1.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-11. (canceled)

12. A storage container for liquefied gas, comprising a first, inner tank extending in a horizontal longitudinal direction (A) and configured to store the liquefied gas, a second, outer tank disposed around the first tank with a vacuum insulated spacing between the first and the second tank, the container comprising a device for supporting the first tank in the second tank, the first tank configured to be maintained at a cryogenic temperature while the second equipment is configured to be maintained at a temperature higher than the temperature of the first equipment, the support device comprising a fixed and rigid connection extending in a longitudinal direction (A) between, on the one hand, one end of the second tank and, on the other hand, an adjacent end of the first tank, the fixed and rigid connection including a set of walls forming back-and-forths in the longitudinal direction (A) to constitute a thermal insulation path between, on the one hand, the second tank and, on the other hand, the first tank, wherein the set of walls forming back-and-forths in the longitudinal direction (A) of the fixed and rigid connection comprises at least one wall made of titanium.

13. The container as claimed in claim 12, wherein the at least one wall made of titanium has a thickness of between 1 mm and 5 mm.

14. The container as claimed in claim 12, wherein the at least one wall made of titanium is a tubular wall.

15. The container as claimed in claim 12, wherein the set of walls forming back-and-forths in the longitudinal direction (A) comprises at least one wall made of stainless steel.

16. The container as claimed in claim 12, wherein the at least one wall made of titanium consists of at least one of the materials selected from the group consisting of TA6V ELI, Ti-5Al-2.5Sn ELI, Ti 6Al 2Zn 4Zr 2Mo and TA6V.

17. The container as claimed in claim 12, wherein the ends of the at least one wall made of titanium are fixed by screwing or welding to respective adjacent elements of the fixed connection.

18. The container as claimed in claim 12, wherein the device for holding the first tank in the second tank comprises two stainless steel walls arranged in series in the thermal path between the two tanks and respectively forming a back-and-forth in the longitudinal direction (A), the two stainless steel walls being arranged in series between the second tank and an intermediate element of the container, the device for holding the first tank in the second tank further comprising at least one titanium wall arranged in series, between the intermediate element of the container and the first tank or a structural element secured to the first tank.

19. The container as claimed in claim 18, wherein the two longitudinal ends of the at least one titanium wall are respectively fixed to the intermediate element of the container and to a structural element secured to the first tank.

20. The container as claimed in claim 19, wherein a longitudinal end of the at least one titanium wall is fixed to the structural element secured to the first tank, said structural element being a tubular neck secured to the first tank.

21. The container as claimed in claim 18, wherein the intermediate element of the container comprises a heat shield arranged between the first and the second tank.

22. The container as claimed in claim 21, wherein the heat shield is cooled by a cryogenic fluid.
